(19) United States
(12) Patent Application Publication
(10) Pub. No.: US 2015/0044466 A1
(43) Pub. Date: Feb. 12, 2015

(54) AQUEOUS SILANE COUPLING AGENT COMPOSITION, MAKING METHOD, SURFACE TREATING AGENT, AND ARTICLE

(71) Applicant: SHIN-ETSU CHEMICAL CO., LTD., Tokyo (JP)

(72) Inventor: Kazuhiro TSUCHIDA, Annaka-shi (JP)

(21) Appl. No.: 14/453,000

(22) Filed: Aug. 6, 2014

(30) Foreign Application Priority Data
Aug. 7, 2013 (JP) 2013-164336

(51) Int. Cl. C08K 5/5419

(52) U.S. Cl. CPC C08K 5/5419
USPC 428/392; 106/287.12; 428/447; 428/429

(57) ABSTRACT

A composition comprising a silane coupling agent having dicarboxylic acid group and water is provided. The composition has a solid content of 0.5-50 wt % based on the entire composition and a volatile organic compound content of up to 10 wt % based on volatile components which are detectable by headspace gas chromatography. The composition is substantially free of volatile organic compounds such as alcohols, does not release volatile compounds with the lapse of time, has improved storage stability under high-temperature conditions, and is effective as modifier.

### CROSS-REFERENCE TO RELATED APPLICATION

This non-provisional application claims priority under 35 U.S.C. §119(a) on Patent Application No. 2013-164336 filed in Japan on Aug. 7, 2013, the entire contents of which are hereby incorporated by reference.

### TECHNICAL FIELD

This invention relates to an aqueous silane coupling agent composition based on a dicarboxylic acid-containing silane compound, a method of preparing the same, a surface treating agent, and an article treated therewith.

### BACKGROUND ART

Organosilicon compounds having a hydrolyzable silyl group and an organic reactive group are generally known as silane coupling agents and often used as adhesives, paint additives and resin modifiers, for example, since they are capable of forming bonds between inorganic materials and organic materials. The problem associated with the use of a silane coupling agent in hydrolyzate form is that it contains a high proportion of a volatile organic solvent which is added as the stabilizer/diluent for an alcohol and silanol resulting from hydrolysis of hydrolyzable silyl groups as typified by alkoxysilyl groups.

In general, silane sol-gel coating materials having a certain level of storage stability may be prepared using partial hydrolyzates of alkoxysilanes and acid-based hydrolytic catalysts. However, these coating materials are limited to alcohol and organic solvent based systems. If the system uses a sufficient amount of water to complete hydrolysis of alkoxysilanes and has a high solid content, then the system undergoes a substantial loss of storage stability and becomes difficult to control hydrolytic condensation of alkoxysilanes in the course of coating material preparation, leading to a molecular weight buildup or gelation.

JP-A 2009-524709 discloses a water-dilutable sol-gel composition essentially comprising glycidyloxypropylalkoxysilane, aqueous silica sol, organic acid, and organometallic compound of titanium or zirconium, which serves as a low alcohol content, aqueous siloxane coating material. With respect to the applications of this composition, only corrosion control coats and primer coats are referred to while its effectiveness is demonstrated nowhere. This coating material leaves a concern that organic acids may remain as the volatile organic compound.

Typical organic reactive groups on silane coupling agents include vinyl, amino, epoxy, (meth)acrylic, mercapto, isocyanate, ketimine structure, and styryl groups. Silane coupling agents having such groups are well known and used in a variety of applications.

Among others, silane coupling agents having an amino group contributing to water solubility have not only a high water solubility, but also a high aqueous solution stability so that an alcohol-free aqueous silane solution may be prepared by removing the alcohol resulting from hydrolysis. They are expected as less environmental load material. On the other hand, the preparation and application of alcohol-free aqueous solutions of silane coupling agents having a carboxylic acid group exhibiting similarly high water solubility have not been reported in the art.

Silane coupling agents having an acid anhydride group capable of generating a carboxylic acid group upon hydrolysis as the functional group and hydrolytic condensates thereof find typical applications as adhesion modifier in pressure-sensitive adhesive compositions (JP-A H08-302320) and crosslinker in curable epoxy resin compositions (JP-A 2006-022158). They are also used as modifier for polyimide resins and in other applications.

JP-A 2012-046576 discloses that a silanol type silane coupling agent having a dicarboxylic acid structure which is obtained from hydrolysis of the acid anhydride-containing silane coupling agent is useful as modifier for encapsulant epoxy resins. No reference is made to the alcohol generated from the coupling agent. This technology falls in the range that silane coupling agents are used in hydrolytic aqueous solution form.

It has been demonstrated that silane coupling agents having an acid anhydride group or carboxylic acid group as the functional group are effective in a wide variety of applications. Materials having similar effects, but not generating volatile organic compounds on use are desired in the related field since they are environment friendly.

### CITATION LIST

Patent Document 1: JP-A 2009-524709 (WO 2007/085320)

Patent Document 2: JP-A H08-302320

Patent Document 3: JP-A 2006-022158

Patent Document 4: JP-A 2012-046576

### DISCLOSURE OF INVENTION

An object of the invention is to provide an aqueous silane coupling agent composition comprising a silane coupling agent having a dicarboxylic acid group as the functional group, which is free of volatile organic compounds such as alcohols, does not release volatile compounds with the lapse of time, has improved storage stability under high-temperature conditions, and is promising as modifier, and a method of preparing the composition. Another object is to provide a surface treating agent comprising the composition and an article treated therewith.

The inventor has found that if an aqueous silane coupling agent composition comprising (i) a silane coupling agent having the general formula (1), defined below, and (ii) water is designed such that a solid content is 0.5 to 50% by weight of the entire composition and the content of volatile organic compounds is up to 10% by weight of volatile components in the composition which are detectable by headspace gas chromatography, this composition is free of volatile organic compounds such as alcohols, does not release volatile compounds with the lapse of time, has improved storage stability under high-temperature conditions, and is promising as modifier.

In a first aspect, the invention provides an aqueous silane coupling agent composition comprising (i) a silane coupling agent having the general formula (1):

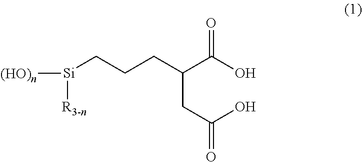

wherein R is a monovalent hydrocarbon group of 1 to 10 carbon atoms and n is 2 or 3, and (ii) water. The composition has a solid content of 0.5 to 50% by weight and contains volatile components which are detectable by headspace gas chromatography, the content of volatile organic compounds being up to 10% by weight of the volatile components.

In a preferred embodiment, the aqueous silane coupling agent composition has a solid content of 30 to 50% by weight and experiences a viscosity buildup of less than 10% when stored at 50° C. for one month.

In a second aspect, the invention provides a method for preparing the aqueous silane coupling agent composition, comprising the steps of hydrolyzing a succinic anhydride-containing silane coupling agent having the general formula (2):

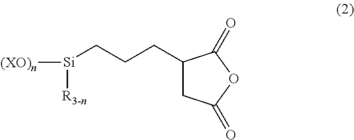

wherein R and n are as defined above, and X is a monovalent hydrocarbon group of 1 to 4 carbon atoms, and removing the alcohol generated.

In a third aspect, the invention provides a surface treating agent comprising the aqueous silane coupling agent composition defined above.

In a fourth aspect, the invention provides an article comprising a substrate treated with the surface treating agent defined above. Preferably, the substrate is a glass fiber member selected from among glass cloth, glass tape, glass mat and glass paper. Also preferably, the substrate is an inorganic filler, ceramic or metal.

### Advantageous Effects of Invention

Since the aqueous silane coupling agent composition is based on a silane coupling agent having a dicarboxylic acid group in a molecule, it exhibits high water solubility and improved stability even in high concentrations. Since the silane coupling agent used in the aqueous silane coupling agent composition is characterized by substantial completion of hydrolysis, the reactivity of silyl group with inorganic materials is high, and the hydrolysis step that prior art silane coupling agents undergo during use is omitted. Therefore, productivity on actual use is high. Since substantially no volatile organic compounds are contained or released, the composition poses minimal burdens to the workers and the working environment. Resins modified with the inventive surface treating agent are tightly bondable to various inorganic materials including glass.

### DESCRIPTION OF PREFERRED EMBODIMENTS

The invention provides a stable aqueous silane coupling agent composition comprising (i) a silane coupling agent having the general formula (1):

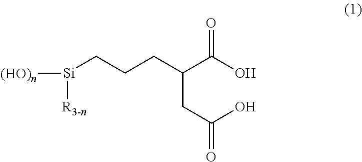

wherein R is a monovalent hydrocarbon group of 1 to 10 carbon atoms, and n is 2 or 3, and (ii) water.

In formula (1), R is a monovalent hydrocarbon group of 1 to 10 carbon atoms, preferably 1 to 6 carbon atoms. Examples include alkyl groups such as methyl, ethyl, propyl, isopropyl, butyl, isobutyl, tert-butyl, pentyl, neopentyl, hexyl, and octyl, cycloalkyl groups such as cyclohexyl, alkenyl groups such as vinyl, allyl, and propenyl, aryl groups such as phenyl, tolyl, xylyl, and naphthyl, and aralkyl groups such as benzyl, phenylethyl and phenylpropyl. Inter alia, methyl, ethyl and phenyl are preferred.

The subscript n is 2 or 3. The silane coupling agent of formula (1) wherein n=1 is inadequate because it generates less silanol upon hydrolysis and thus exhibits low water solubility, insufficient stability in aqueous solution, and low reactivity to inorganic materials.

The aqueous silane coupling agent composition contains volatile components which are detectable by headspace gas chromatography. The content of volatile organic compounds should be up to 10% by weight, preferably up to 5% by weight of the volatile components, and most preferably nil. If the content of volatile organic compounds exceeds 10% by weight, the composition poses substantial burdens to the workers and the surrounding environment and fails to attain the objects of the invention.

The “volatile organic compounds” mainly refer to alcohols resulting from hydrolysis of alkoxysilyl groups on the silane coupling agent. Also, water-miscible organic solvents such as alcohols which are intentionally added as a stabilizer to a silane coupling agent aqueous solution, as alluded to previously, and organic acids which are used as hydrolytic catalyst for silanes are included in the “volatile organic compounds.”

The aqueous silane coupling agent composition should have a solid content of 0.5 to 50% by weight, preferably 30 to 50% by weight, and more preferably 30 to 40% by weight based on the entire composition. Specifically, the amount (g) of solids remaining when the composition is heated and dried, divided by the total amount (g) of the initial composition should range from 0.005 to 0.5. If the solid content is less than 0.5% by weight, the composition forms a film which does not exhibit sufficient water resistance and primer effect. If the solid content exceeds 50% by weight, the composition becomes difficult to prepare because of a substantial loss of stability.

In a preferred embodiment, the aqueous silane coupling agent composition has a solid content of at least 30% by weight based on the entire composition, and experiences a viscosity buildup of less than 10% when stored at 50° C. for one month. Notably, the viscosity is measured at 25° C. by a capillary kinematic viscometer.

The aqueous silane coupling agent composition may be prepared by hydrolyzing a succinic anhydride-containing silane coupling agent having the general formula (2) and removing the alcohol generated.

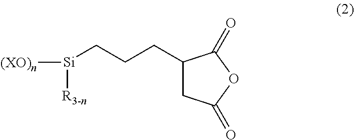

Herein R and n are as defined above, and X is a monovalent hydrocarbon group of 1 to 4 carbon atoms. The step of removing the alcohol generated from hydrolysis ensures that the content of volatile organic compounds (mainly alcohols) is up to 10% by weight of the volatile components which are detectable by headspace gas chromatography (GC).

In formula (2), X is a monovalent hydrocarbon group of 1 to 4 carbon atoms, examples of which include alkyl groups such as methyl, ethyl, propyl, isopropyl, butyl, isobutyl, and tert-butyl. Inter alia, methyl and ethyl are preferred.

Examples of the succinic anhydride-containing silane coupling agent include (trimethoxysilyl)propylsuccinic anhydride, (triethoxysilyl)propylsuccinic anhydride, (methyldimethoxysilyl)propylsuccinic anhydride, and (methyldiethoxysilyl)propylsuccinic anhydride, but are not limited thereto.

It is not always true that a stable aqueous silane coupling agent composition is prepared from any silane coupling agents. In the practice of the invention, the dicarboxylic acid structure created by hydrolysis becomes a key skeleton in obtaining the desired aqueous material.

Suitable hydrolysis conditions include a temperature of 30 to 110° C. and a reduced pressure of 60 hPa to atmospheric pressure, but are not limited thereto as long as the stability of the resulting composition is not adversely affected. If the reaction temperature exceeds 110° C., the composition may become difficult to prepare because of a substantial loss of stability. If the reaction temperature is lower than 30° C., hydrolysis reaction may not fully proceed, leaving the risk of alcohol release with the lapse of time.

The step of removing the generated alcohol after the hydrolytic reaction may be conducted, for example, by atmospheric distillation and vacuum distillation. The distillation step may be conducted subsequently to or concurrently with the hydrolytic reaction step. From the standpoint of production efficiency, the distillation step concurrent with the hydrolytic reaction step is preferred. The temperature and pressure conditions during the concurrent step are the same as those during the hydrolytic reaction step.

The amount of water used in hydrolytic reaction is at least 4 moles per mole of the reactant, succinic anhydride-containing silane coupling agent. Any excess of water may be present in the hydrolytic reaction system because the inventive composition is substantially based on water as solvent.

On hydrolysis of the silane coupling agent, no hydrolytic catalysts known in the art are used. On use of such a catalyst, it may be left at the end of alcohol removal step subsequent to hydrolysis. The composition containing residual catalyst is undesirable from the aspect of environmental load because the catalyst can be a volatile organic compound.

Since the main component has a silanol-containing structure as alluded to previously, the aqueous silane coupling agent composition functions by itself as a surface treating agent, for example, a primer or a modifier for composites of inorganic material and organic resin. The surface treating agent should preferably contain the main component or silane coupling agent in a concentration of 0.1 to 50%, more preferably 0.5 to 30% by weight of the entire surface treating agent.

Besides the aqueous silane coupling agent composition, additives such as surfactants, preservatives, discoloration preventive agents and antioxidants may be blended in the surface treating agent as long as the objects of the invention are not impaired.

The surface treating agent is used for surface treatment of substrates, while the substrates may be made of inorganic materials which form bonds by reacting with hydrolyzable silyl groups and organic materials such as organic resins which form bonds by reacting with carboxylic acid groups. The shape of substrates is not particularly limited. Typical inorganic materials include inorganic fillers of silicon, titanium, zirconium, magnesium, aluminum, indium, tin, and single, double or complex oxides thereof, fiber glass members such as glass fibers, glass cloth, glass tape, glass mat, and glass paper, ceramics, and metal substrates such as iron, aluminum, copper, silver, gold and magnesium. Typical organic materials include epoxy resins, phenolic resins, polyimide resins, unsaturated polyester resins, paper boards, wood, solid wood boards, laminated wood boards, and chip boards. The substrate is not limited to the materials illustrated herein.

In the surface treatment of a substrate with the surface treating agent, the treatment mode and curing conditions are not particularly limited. For example, the surface treating agent may be directly applied to the substrate by flow coating, dipping or spin coating. Also applicable is a kneading treatment wherein the surface treating agent is added to and mixed with a compound composed of an untreated inorganic filler and a resin as dispersing medium.

Typical curing conditions include heating and drying. Preferably, the surface treatment is followed by heating and drying at 60 to 180° C., more preferably 80 to 150° C. for 5 minutes to 2 hours, for thereby removing the solvent and inducing chemical reaction between the silane coupling agent, which is the main component of the surface treating agent, and the substrate surface.

### EXAMPLE

Examples and Comparative Examples are given below for illustrating the invention, but the invention is not limited thereto. In Examples, all parts are by weight; viscosity is measured at 25° C. according to JIS Z 8803, specific gravity measured at 25° C. according to JIS Z 8804, and refractive index measured at 25° C. according to JIS K 0062.

An alcohol content was measured by using a headspace autosampler TurboMatrix HS40 (Perkin Elmer Inc.), charging a vial having a volume of 20 mL with 1 g of a sample, sealing the vial with a septum, holding the sample at 60° C. for 10 minutes until gas-liquid equilibrium was reached, and collecting the gas component.
GC system: HP7820A by Agilent Technologies
Detector: thermal conductivity detector (TCD)
Column: HP Innowax 19091N-033 (length 30 m×inner diameter 0.25 mm×film thickness 0.15 μm)

Column temperature: 40° C. (1.5 min holding)→15° C./min→80° C. (4 min holding), total measurement time 8.2 min

Injector temperature: 250° C.

Detector temperature: 250° C.

Carrier gas: He

Carrier gas flow rate: 1.4 mL/min

### Preparation of Aqueous Silane Coupling Agent Composition

### Example 1

A 1-L separable flask equipped with a stirrer, reflux condenser, dropping funnel and thermometer was charged with 262.3 parts of (trimethoxysilyl)propylsuccinic anhydride (X-12-967C by Shin-Etsu Chemical Co., Ltd.), to which 1,000 parts of deionized water was admitted. The contents were stirred and heated. Methanol formed by reaction and water were distilled off under atmospheric pressure, until an internal temperature of about 100° C. was reached. The amount of methanol and water distilled off at this point totaled to 500 parts. Deionized water was added to the reaction product to form a composition having a solid content of 30 wt %, which was a pale yellow clear liquid having a viscosity of 4.1 mm²/S, a specific gravity of 1.10, a refractive index of 1.374, pH 1.9, and a methanol content of less than 0.1 wt % as measured by headspace GC.

The reaction product is represented by the following formula.

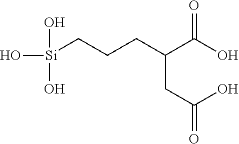 [SMILES: O=C(O)CC(CCC[Si](O)(O)O)C(=O)O]

### Example 2

A reaction product was prepared as in Example 1 except that (methyldimethoxysilyl)propylsuccinic anhydride was used instead of (trimethoxysilyl)propylsuccinic anhydride. Deionized water was added to the reaction product to form a composition having a solid content of 30 wt %, which was a pale yellow clear liquid having a viscosity of 8.4 mm²/s, a specific gravity of 1.06, a refractive index of 1.351, pH 1.9, and a methanol content of less than 0.1 wt % as measured by headspace GC.

The reaction product is represented by the following formula.

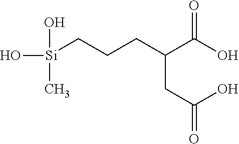

### Comparative Example 1

### Preparation of Hydrolyzate 1 in Example of JP-A 2012-046576

A 1-L separable flask equipped with a stirrer, reflux condenser, and thermometer was charged with 262.3 parts of (trimethoxysilyl)propylsuccinic anhydride (X-12-967C by Shin-Etsu Chemical Co., Ltd.), to which 144 parts of deionized water was admitted. The contents were thoroughly stirred until the mixture ceased to separate into two layers. The end product was obtained as a pale yellow clear liquid. The end product had a methanol content of 15 wt % as measured by headspace GC. On IR analysis, peaks assigned to carboxyl group were observed while peaks assigned to acid anhydride vanished.

### Comparative Example 2

The procedure of Example 1 was repeated except that (dimethylmethoxysilyl)propylsuccinic anhydride was used instead of (trimethoxysilyl)propylsuccinic anhydride. The reaction solution was uniform during hydrolysis. In the subsequent alcohol removal step, the solution increased its viscosity in proportion to methanol removal and eventually lost fluidity, failing to yield the desired material.

### Evaluation of Adhesion Between Glass Fibers and Epoxy Resin

### Examples 3 and 4 and Comparative Examples 3 to 5

The reaction product obtained above or (trimethoxysilyl)propylsuccinic anhydride was diluted with water to form a 1 wt % dilution, which was used as surface treating agent. Glass filaments having a diameter of 20 μm were treated with the agent and dried at 100° C. for 30 minutes, yielding surface treated glass filaments. Onto the surface treated glass filaments, a heat curable composition consisting of an epoxy resin (JER828 by Japan Epoxy Resin Co., Ltd.) and a curing agent (triethylene tetramine) was applied as droplets having a diameter of several tens to several hundreds of microns such that the droplets might not contact with each other, and heat cured (specifically heated at 80° C. for 1.5 hours and at 100° C. for further 2 hours) to form a spherical resin bead. The shear strength between surface treated glass filament and epoxy resin was measured by the micro-droplet method using an analyzer for evaluation of interfacial properties of composite materials (HM410 by Tohei Sangyo Co., Ltd.). The shear strength τ (MPa) per unit area is given as τ=F/πDL wherein D (μm) is the diameter of a filament, L (μm) is the length of a portion of the filament buried in the resin bead, and F (mN) is the load required to withdraw the resin bead in filament axial direction. Table 1 shows the main component of the surface treating agent and the measurements of shear strength.

TABLE 1

| | Surface treating agent's | Shear strength |
|---|---|---|
| | main component | (MPa) |
| Example | | |
| 3 | Product of Example 1 | 38.9 |
| 4 | Product of Example 2 | 36.3 |
| Comparative | | |
| Example | | |
| 3 | not added (untreated) | 33.7 |
| 4 | X-12-967C | 33.1 |
| 5 | Product of Comparative Example 1 | 25.6 |

X-12-967C: (trimethoxysilyl)propylsuccinic anhydride

The test results of Examples and Comparative Examples demonstrate that the surface modified with the surface treating agents of the invention is effective for promoting adhesion to epoxy resins, and the efficiency of treatment of glass filaments is improved owing to thorough hydrolysis, exerting a satisfactory coupling effect.

### Evaluation of Adhesion Between Silver Substrate and Encapsulating Epoxy Resin

### Examples 5 and 6 and Comparative Examples 6 to 8

An encapsulating epoxy resin compound having the formulation shown in Table 2 was prepared according to the Example of JP-A 2012-046576. A tablet of the resin compound was integrally molded to a silver substrate at 175° C. and 6.9 MPa for 2 minutes to form a frustoconical epoxy resin part (top diameter 3 mm, bottom diameter 3.6 mm, height 3 mm, interface area 10 mm²) on the silver substrate (diameter 3.6 mm, thickness 0.5 mm). With the silver substrate fixedly secured, a torque needed to force the epoxy resin part at its side until separation was measured. The results are shown in Table 2.

In Table 2, the amount of the aqueous silane coupling agent composition added is expressed in terms of the amount of its main component, that is, solid content.

TABLE 2

| Formulation | Example | | Comparative Example | | |
|---|---|---|---|---|---|
| (pbw) | 5 | 6 | 6 | 7 | 8 |
| Product of Example 1 | 0.2 | | | | |
| Product of Example 2 | | 0.2 | | | |
| Product of Comparative | | | 0.2 | | |
| Example 1 | | | | | |
| X-12-967C | | | | 0.2 | |
| Epoxy resin | 5.6 | 5.6 | 5.6 | 5.6 | 5.6 |
| Phenolic resin | 5.5 | 5.5 | 5.5 | 5.5 | 5.5 |
| curing agent | | | | | |
| Inorganic filler | 88 | 88 | 88 | 88 | 88 |
| Silane coupling agent | 0.1 | 0.1 | 0.1 | 0.1 | 0.1 |
| Cure promoter | 0.2 | 0.2 | 0.2 | 0.2 | 0.2 |
| Parting agent | 0.2 | 0.2 | 0.2 | 0.2 | 0.2 |
| Coloring agent | 0.3 | 0.3 | 0.3 | 0.3 | 0.3 |
| Adhesion to Ag | 12 | 11 | 9 | 7 | 4 |
| substrate (N) | | | | | |

| | |
|---|---|
| X-12-967C: | (trimethoxysilyl)propylsuccinic anhydride |
| Epoxy resin: | YX-400K by Mitsubishi Chemical Corp. |
| Phenolic resin | MEH-7851SS by Meiwa Plastic Industries, Ltd. |
| curing agent: | |
| Inorganic filler: | spherical fused silica, average particle |
| | size 10.8 μm, BET surface area 5.1 m²/g |
| Silane coupling agent: | KBM-573 by Shin-Etsu Chemical Co., Ltd. |
| Cure promoter: | addition product of triphenylphosphine and |
| | p-benzoquinone |
| Parting agent: | oxidized polyethylene wax PED 191 by |
| | Clariant |
| Coloring agent: | carbon black Carbon #5 by Mitsubishi |
| | Chemical Corp. |

The results of Examples and Comparative Examples demonstrate that the surface modification by integral blending of the surface treating agent of the invention is effective for improving adhesion to epoxy resin, and the efficiency of treatment of silica and silver substrate is improved owing to thorough hydrolysis, exerting a satisfactory coupling effects.

### Evaluation of Stability of Aqueous Silane Coupling Agent Composition

### Examples 1 and 2 and Comparative Example 9

The compositions of Examples 1 and 2 and the composition of Comparative Example 9 which was obtained by adjusting the composition of Example 1 to a solid content of 60% by weight, in sealed state, were stored in a thermostat chamber at 50° C. Table 3 shows a percent buildup of viscosity from the initial viscosity with passage of time.

TABLE 3

| | Viscosity buildup (%) during 50° C. storage | | |
|---|---|---|---|
| | After 10 days | After 30 days | After 60 days |
| Example 1 | 0.5 | 0.4 | 0.5 |
| Example 2 | 0.5 | 0.7 | 1.1 |
| Comparative Example 9 | 3.1 | 22.6 | gelled |

| | |
|---|---|
| Comparative Example 9: | obtained by adjusting the composition of |
| | Example 1 to a solid content of 60% by weight |

As seen from the results of Examples and Comparative Examples, aqueous silane coupling agent compositions of the invention maintain satisfactory stability even at a high temperature of 50° C.

Japanese Patent Application No. 2013-164336 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. An aqueous silane coupling agent composition comprising (i) a silane coupling agent having the general formula (1): 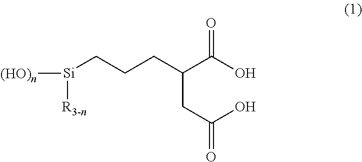
wherein R is a monovalent hydrocarbon group of 1 to 10 carbon atoms and n is 2 or 3, and (ii) water,
the composition having a solid content of 0.5 to 50% by weight and containing volatile components which are detectable by headspace gas chromatography, the content of volatile organic compounds being up to 10% by weight of the volatile components.

2. The aqueous silane coupling agent composition of claim 1 which has a solid content of 30 to 50% by weight and experiences a viscosity buildup of less than 10% when stored at 50° C. for one month.

3. A method for preparing the aqueous silane coupling agent composition of claim 1, comprising the steps of hydrolyzing a succinic anhydride-containing silane coupling agent having the general formula (2): 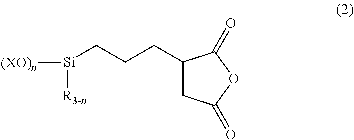
wherein R and n are as defined above, and X is a monovalent hydrocarbon group of 1 to 4 carbon atoms, and removing the alcohol generated.

4. A surface treating agent comprising the aqueous silane coupling agent composition of claim 1.

5. An article comprising a substrate treated with the surface treating agent of claim 4.

6. The article of claim 5 wherein the substrate is a glass fiber member selected from the group consisting of glass cloth, glass tape, glass mat and glass paper.

7. The article of claim 5 wherein the substrate is an inorganic filler.

8. The article of claim 5 wherein the substrate is ceramic or metal.
